(19) United States
(12) Patent Application Publication
(10) Pub. No.: US 2003/0191853 A1
(43) Pub. Date: Oct. 9, 2003

(54) Method and apparatus for controlling traffic flow rate

(76) Inventor: Yoshitsugu Ono, Yokohama (JP)

Correspondence Address: MCDERMOTT WILL & EMERY, 600 13TH STREET, N.W., WASHINGTON, DC, 20005-3096, US

(21) Appl. No.: 10/369,125

(22) Filed: Feb. 20, 2003

(30) Foreign Application Priority Data
Apr. 3, 2002 (JP) 2002-101398

(51) Int. Cl. G06F 15/16

(52) U.S. Cl. 709/232

(57) ABSTRACT

A management server requests a meter installed in the network to measure traffic flow rates of transmitted data for each transmission direction of a communication line connecting routers subjected to traffic management and for each identifier included in the transmitted data. The management server aggregates the measured flow rates to create acquired flow-rate data. Then, the management server finds an average value of the measured flow rates and computes a send-out rate to be used as a flow-rate policy by multiplying the average value by a weight according to the identifier for which the flow rates have been acquired. Finally, the management server requests each of the routers to set such a flow-rate policy therein. As requested, each of the routers controls a flow rate for each identifier in accordance with the flow-rate policy set therein.

### BACKGROUND OF THE INVENTION

The present invention relates generally to a technology for controlling a traffic flow rate in a network. More particularly, the present invention relates to a technology for controlling a traffic flow rate of transferred data by considering a service level of the transferred data.

In particular control of transfers of data through a network, the control is executed in dependence on an identified class of the data. A class of the transferred data is normally identified by a first router at an entrance of the network subjected to traffic management. An identifier is embedded in a ToS field (Refer to RFC 1493) of an IP header of the transmitted data. That is to say, in the network subjected to traffic management, the class of the transmitted data is identified on the basis of the embedded identifier. As a typical technique of executing band control in a network subjected to traffic management on the basis of such identifiers, there is known a model called DiffServ (Refer to RFCs 2474, 2475, 2597 and 2598). In this case, in the network subjected to traffic management, each transmitted data's attributes such as an IP address and an application are not taken into consideration at all in determining of the class of the data. In other words, the class of the transferred data is identified by using only a value embedded in the ToS field in order to execute transfer control suitable for the class.

A system utilizing such a technology is disclosed in Japanese Patent Laid-open No. 2001-244979. In this system, classes are used for identifying categories of rendered services and do not show priority levels of data transfers.

An identified class of a data transfer is defined as a priority level of the data transfer. In order to deliver data in such a way that, the higher the priority level, the sooner the data is delivered, routers in a network subjected to traffic management generally each adopt a priority-based queuing technique whereby a packet having a high priority level is transmitted, taking precedence of a packet having a low priority level. As a system for managing traffic in a network, a technology is disclosed in documents such as Japanese Patent Laid-open No. 11-136237.

In accordance with the priority-based queuing technique adopted as the prior art in a network subjected to traffic management, a priority level of data transmitted by way of the network is determined on the basis of an identifier included in the data. It is needless to say that data with a high priority level is transmitted, taking precedence of other data so that transmission of data with a low priority level is inadvertently deferred. With such a technique, in a state of heavy traffic of pieces of data with high priority levels, data with a low priority level unavoidably enters a wait state in a router, being not transmitted for any length of time. While a technique of delaying transmission of data with a low priority level is a proper method, a big effect of the priority level on the arrival time of data is inefficiency.

In order to solve the problem described above, there have been proposed control methods such as the WFQ (Weighted Fair Queuing) technique and the WRR (Weighted Round Robin) technique. In accordance with the WFQ and WRR techniques, a router defines a send-out rate in advance for each class required for controlling data transfers. Data pertaining to a class is transmitted at a send-out rate defined for the class constantly on a priority basis. In this case, if data has an amount exceeding a send-out rate defined for the class to which the data pertains, the excess portion of the data is diverted into another class with a defined send-out rate thereof greater than the amount of other data pertaining to the other class. When an excess portion of specific data is diverted into another class to which other data pertains, however, the priority level of the specific data and the priority level of the other data are not taken into consideration. That is to say, an excess portion of specific data with a high priority level may be inadvertently diverted into another class to which other data with a low priority level pertains. As a result, send-out rates assigned to each router inadvertently have a big effect on the operation.

### SUMMARY OF THE INVENTION

With the prior art, however, a send-out rate defined for each class depends on the sense of a person in charge of network management and the number of users at each service level to a certain degree. That is to say, setting of an optimum send-out rate is not absolutely assured. In addition, since the amount of traffic flowing through a router varies from router to router, it is extremely difficult to identify a send-out rate for each router. In addition, the amount of network traffic changes constantly so that, even if parameters appropriate at a particular time for all routers are set, the values of the parameters may not always be proper for the routers at other times. Furthermore, it is very hard for a person in charge of network management to grasp routes in a network subjected to traffic management. Even if all routes can be grasped, it is impossible to keep up with an abnormality state in which a flow of data transmitted through a route is detoured in the event of a failure occurring in a router on the route.

It is therefore an object of the present invention to provide a technology for dynamically changing a flow rate in accordance with traffic in a network without increasing a load borne by a person in charge of network management.

The present invention provides a technology for contoling a flow rate of traffic through a communication line in a network including a plurality of routing controllers and the communication line connecting the routing controllers. The technology provided by the present invention is characterized in that the technology is applied to control comprising the steps of: sampling traffic flow rates for each transmission direction of the communication line and for each identifier included in transmitted data; aggregating the sampled traffic flow rates to find an average value of the sampled traffic flow rates; finding a send-out rate by multiplying the average value by a weight according to the identifier to be used as a flow-rate policy; and transmitting the send-out rate to one of the routing controllers to set the send-out rate as the flow-rate policy.

In addition, the present invention also provides a traffic flow-rate control technology to be adopted by a system, which has a management means for managing traffic flow rates in a network, for the purpose of controlling a traffic flow rate of transmitted data flowing through a communication line in the network comprising a plurality of transmission means, the communication line connecting the transmission means to each other and a measurement means for measuring the traffic flow rate. The traffic flow-rate control technology provided by the present invention is characterized in that the technology is applied to control comprising the steps of: driving the measurement means to measure a traffic flow rate of data transmitted through the communication line for each transmission direction of the communication line and for each identifier included in the transmitted data and transmit the measured traffic flow rates to the management means in accordance with a request received from the management means; and driving each of the transmission means to receive a send-out rate as a flow-rate policy set for each transmission direction of the communication line and for each identifier included in the transmitted data from the management means and control the flow rate of the transmitted data for each identifier included in the transmitted data in accordance with the send-out rate received from the management means.

### BRIEF DESCRIPTION OF THE DRAWINGS

FIG. 1 is a diagram showing a system configuration of an embodiment;

FIG. 2 is a diagram showing an exemplified data format of resource information 201;

FIG. 3 is a diagram showing exemplified resources identified by resource IDs;

FIG. 4 is a diagram showing an exemplified data format of a service level definition 401;

FIG. 5 is a diagram showing exemplified identifiers set in transmitted data;

FIG. 6 is a diagram showing an exemplified data format of an initial flow rate policy 601;

FIG. 7 is a diagram showing an exemplified structure of flow rate policy data;

FIG. 8 is an explanatory diagram showing flows of data 501 transmitted in a router 102;

FIG. 9 shows a flowchart representing a procedure of a process carried out by a flow-rate acquisition unit 111 employed in the embodiment;

FIG. 10 is a diagram showing exemplified flow rates;

FIG. 11 shows a flowchart representing a procedure of a process carried out by a flow-rate aggregation unit 110 employed in the embodiment;

FIG. 12 is a diagram showing an example of aggregated flow rate data;

FIG. 13 is a diagram showing an example of a graph representing changes in flow rate with the lapse of time;

FIG. 14 shows a flowchart representing a procedure of a process carried out by a flow-rate-policy control unit 107 employed in the embodiment; and

FIG. 15 is a diagram showing exemplified flow-rate policy data.

### DETAILED DESCRIPTION OF THE PREFERRED EMBODIMENTS

Preferred embodiments of the present invention will be described taking an example of Diffserv model into account with reference to the accompanying drawings below.

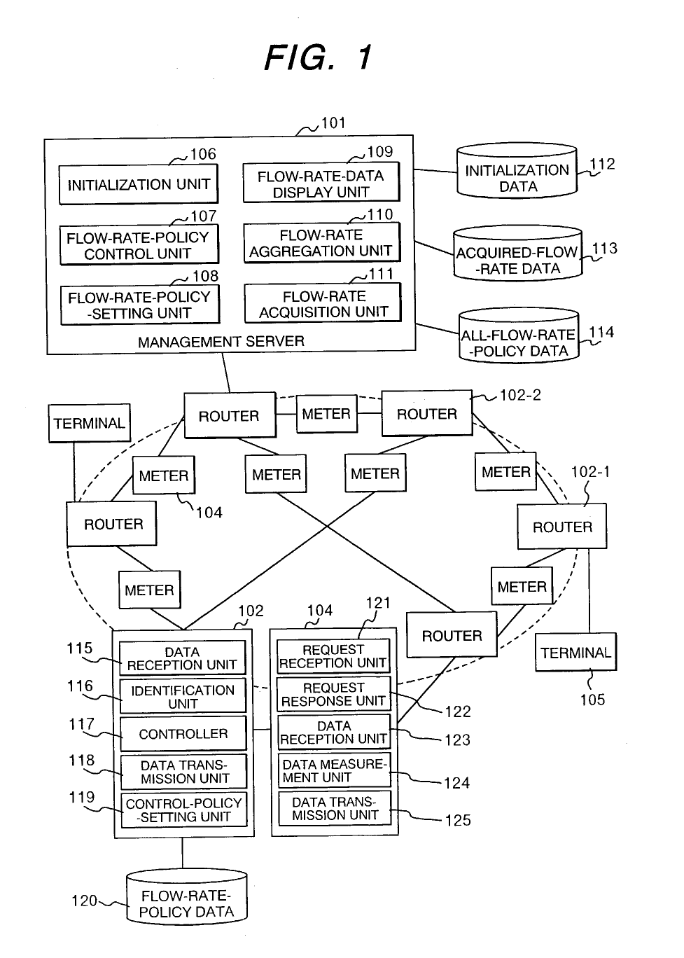

FIG. 1 is a diagram showing a system configuration of an embodiment. An area enclosed by a dashed line in the figure is a network subjected to traffic management. As shown in the figure, the network includes routers 102 and meters 104. A router 102-1 is an edge router, which is a router connected to a terminal 105 utilized by an end user. On the other hand, a router 102-2 is a core router, which is a router not connected to the terminal 105. As shown in the figure, the routers 102 and the meters 104 are connected to each other by communication lines. In addition, one of the routers 102 is connected to a management server 101 by communication lines. The management server 101 is a computer connected to the network subjected to traffic management. The management server 101 collects traffic information from the meters 104 in the range of traffic management in order to set a flow-rate policy of traffic in each of the routers 102 in the range of traffic management. The management server 101 has an initialization data 112, an acquired-flow-rate data 113 and an all-flow-rate data 114 stored in storage devices of the management server 101. In addition, the management server 101 includes a initialization unit 106, a flow-rate-policy control unit 107, a flow-rate-policy-setting unit 108, a flow-rate-data display unit 109, a flow-rate aggregation unit 110 and a flow-rate acquisition unit 111 as configuration components implemented by software and/or hardware. Processing procedures of these configuration components are implemented by execution of programs by the management server 101 as will be described later in detail.

The router 102 has the flow-rate-policy data 120 stored in the storage device employed in the router 102. The router 102 also has a data reception unit 115, an identification unit 116, a controller 117, a data transmission unit 118 and a control-policy-setting unit 119 as configuration components implemented by software and/or hardware. The control-policy-setting unit 119 receives flow-rate policy data from the management server 101 and stores the data in the flow-rate-policy data 120. The data reception unit 115 receives data flowing into the router 102. The identification unit 116 distributes pieces of received data to a plurality of queues in accordance with identifiers set in the data. The controller 117 determines a queue from which data is to be output and an output destination of the data in accordance with the contents of the flow-rate-policy data 120. The data transmission unit 118 sends out the data of the determined queue from the router 102. It is to be noted that a transmission apparatus including a routing controller as one of its components can be utilized as a substitute for the router 102 specially used for routing.

In this embodiment, a meter 104 is an apparatus intercepting a communication line connecting two routers 102 to each other. The meter 104 comprises a request reception unit 121, a request-response unit 122, a data reception unit 123, a data measurement unit 124 and a data transmission unit 125 as configuration components implemented by software and/or hardware. The data reception unit 123 receives data flowing into the meter 104 from the intercepted communication line. The data transmission unit 125 outputs data from the meter 104 to the intercepted communication line. The request reception unit 121 receives a request for a measurement of traffic from the management server 101. The data measurement unit 124 is placed between the data reception unit 123 and the data transmission unit 125 and used for measuring a flow rate of data for each requested identifier. The request-response unit 122 transmits traffic information measured by the data measurement unit 124 to the management server 101.

The initialization unit 106 employed in the management server 101 catalogs information required at an operation stage in the initialization data 112. The initialization data 112 is used for storing tables such as resource information 201, a service-level definition 401 and an initial flow-rate policy 601 as well as an interval of setting the flow-rate policy, an interval of acquiring flow-rate information and an interval of aggregating flow rates.

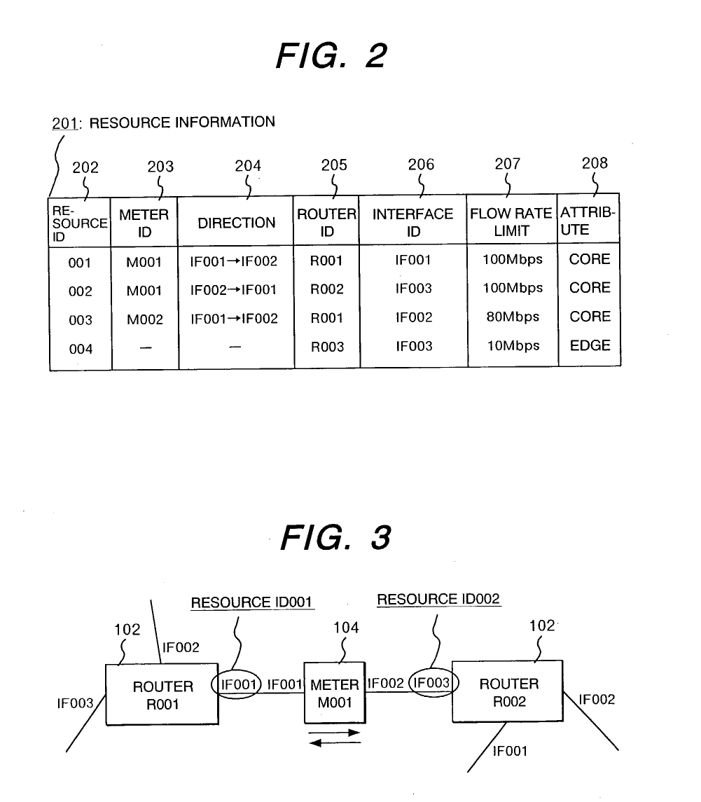

FIG. 2 is a diagram showing an exemplified data format of the resource information 201. A resource shown in the figure refers to a specific interface of a particular router 102. The resource is identified by a pair of a router ID 205 and an interface ID 206. An interface of a router 102 is a port of a line emanating from the router 102. A resource ID 202 is another identifier for uniquely identifying a specific resource among all resources of all the routers 102. A meter ID 203 associated with a resource ID is an identifier for identifying a meter 104 for measuring the flow rate of data flowing to a resource identified by the resource ID. A direction 204 associated with a meter ID 203 is represented by a pair of an input interface and an output interface, which are associated with a meter 104 identified by the meter ID 203. An interface of a meter 104 is a port of a line emanating from the meter 104. Thus, a direction of transmitted data flowing through a resource is identified by a meter ID 203 and a direction 204. A flow-rate limit 207 associated with a resource ID 202 is a limit of a flow rate of a flow in the direction of transmitted data flowing through the resource identified by the resource ID 202. An attribute 208 associated with a resource ID 202 indicates whether the router 102 owning a resource identified by the resource ID 202 is a core router or an edge router. As is obvious from the table, a meter 104 measures a flow rate for each of two resources, which have different directions of transmitted data.

FIG. 3 is a diagram showing as an example a resource identified by a resource ID of 001 and a resource identified by a resource ID of 002. A router 102 identified by R001 has interfaces identified by IF001, IF002 and IF003. A router 102 identified by R002 has interfaces identified by IF001, IF002 and IF003. These two routers 102 are connected through a meter 104 identified by M001. The meter 104 has interfaces identified by IF001 and IF002. The meter 104 identified by M001 measures the flow rate of data output by the resource identified by the resource ID of 001 in the direction from IF001 to IF002 of the meter 104. On the other hand, the meter 104 identified by M001 measures the flow rate of data output by the resource identified by the resource ID of 002 in the direction from IF002 to IF001 of the meter 104. Thus, in accordance with the technique described above, data's flow rates measured by the meter 104 are each associated with a resource outputting the data.

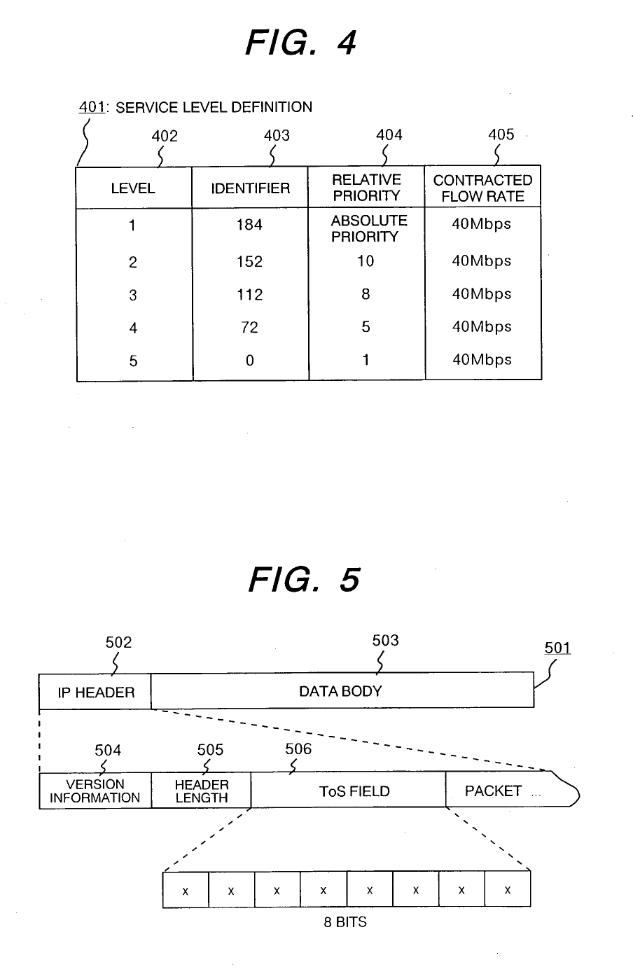

FIG. 4 is a diagram showing an exemplified data format of the service level definition 401. A number is assigned to each service level 402, which is associated with an identifier 403. An identifier 403 is a value set in a ToS field 506 in an IP header 502 of transmitted data 501, which has a data structure shown in FIG. 5. The value set in a ToS field 506 is used for identifying a service level of the transmitted data 501. The identifier 403 corresponds to a DSCP (DiffServ Code Point) in the case of DiffServ. A relative priority 404 assigned to a service level 402 is a priority level relative to other service levels. In other words, a relative priority 404 is a value corresponding to a weight for the service level or the identifier 403 associated with the relative priority 404.

In the data format shown in FIG. 4, the data with a service level of 5 is data treated at the lowest priority level. Pieces of data having service levels of 4, 3 and 2 respectively are treated at gradually increasing priority levels. In addition, in order to assure the quality of communication, a desired minimum band that can be absolutely assured is considered as is the case with an EF (Expedited Forwarding) feature of DiffServ. In this case, a service level treated absolutely at the highest priority level by ignoring relative priorities of other service levels is defined. By using this service level treated absolutely at the highest priority level, it is possible to assure data of a minimum amount even in the event of a traffic jam. A contracted flow rate 405 is a flow rate contracted for each service level in an initial state of an operation.

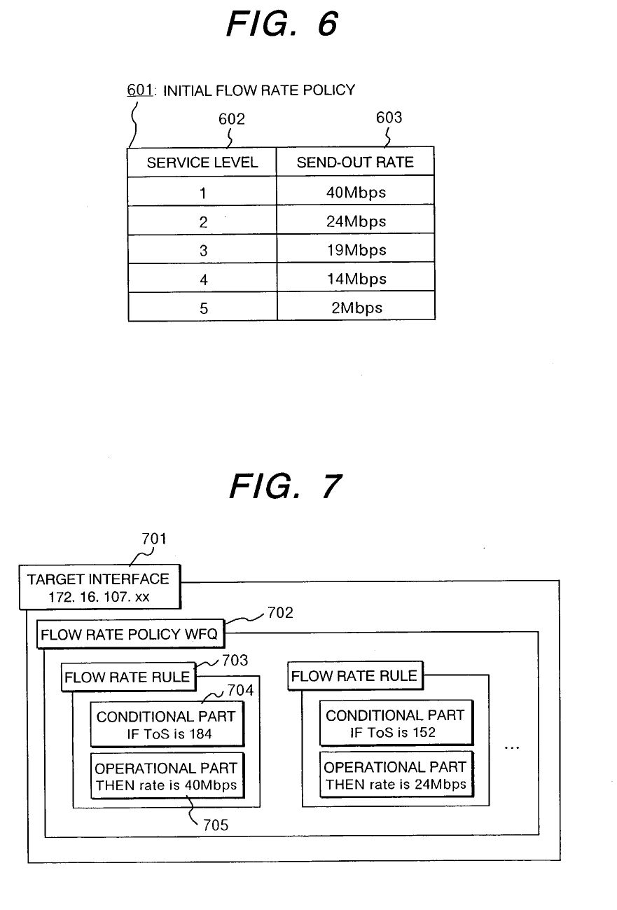

FIG. 6 is a diagram showing an exemplified data format of the initial flow rate policy 601. The initial flow rate policy 601 is a table for storing a send-out rate 603 in an initial state of an operation for each resource and each service level 602. The initialization unit 106 creates the initial flow-rate policy 601.

In the initial flow-rate policy 601, the service level of 1 treated at the absolute priority level has the contracted flow rate 405 thereof as the send-out rate 603. The send-out rate 603 of a service level other than the service level of 1 is found by using the following equation:

$${r}_{n} = \frac{( V - {r}_{1} ) {γ}_{n} {W}_{n}}{\sum {γ}_{k} {W}_{k}} \qquad ( Equation 1 )$$

where symbol rn denotes the send-out rate 603 of service level n, symbol V denotes the flow-rate limit 207 of the line, symbol γn or γk denotes the relative priority 404 of level n or k respectively whereas symbol Wn or Wk denotes contracted flow rate 405 of level n or k respectively.

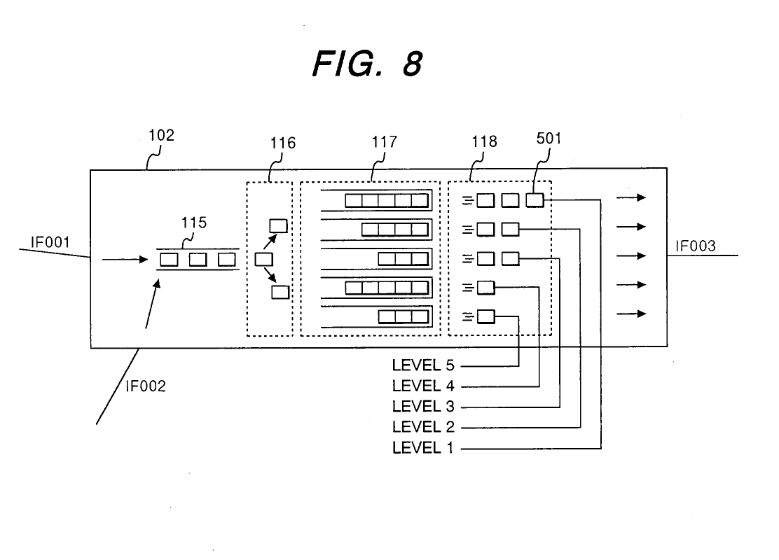

FIG. 7 is a diagram showing an exemplified structure of flow rate policy data transmitted by the management server 101 to a router 102 and set by the router 102. A target interface 701 refers to a resource identified by a resource ID 202. In this case, the target interface 701 is expressed by an IP address for identifying a specific interface of a particular router. A flow-rate policy 702 comprises a plurality of flow-rate rules 703, which each include a conditional part 704 and an operational part 705. A flow-rate rule 703 indicates that, if the condition of the conditional part 704 is satisfied, control shall be executed at the send-out rate of the operational part 705 in the same flow-rate rule 703 as the conditional part 704. The flow-rate-policy-setting unit 108 converts the initial flow-rate policy 601 for each resource into a flow-rate policy described in a data format shown in FIG. 7 and transmits the flow-rate policy obtained as a result of conversion to a router having the resource. The control-policy-setting unit 119 receives the flow-rate policy, converts the policy-into data with a table format and stores the data in the flow-rate-policy data 120. After the setting operation, the flow-rate-policy-setting unit 108 stores the initial flow-rate policy 601 in the all-flow-rate-policy data 114.

FIG. 8 is an explanatory diagram showing a model representing flows of data 501 transmitted in a router 102. The data reception unit 115 receives transmitted data 501. The identification unit 116 stores the data 501 in a queue selected in accordance with the value set in the ToS field of the data 501. The controller 117 executes control to output data from each queue on the basis of the contents of the flow-rate-policy data 120 so as to achieve a rate determined in advance for the queue. If the data stored in a queue is of too small quantity to satisfy the rate determined for the queue, the remaining time can be spent instead to send out data from any other queue. The data transmission unit 118 passes on data received from the queues to a communication line. In general, the router 102 is a special-purpose router or, as a substitute for the special-purpose router, a transmission apparatus or a transmission means can be employed as far as the transmission apparatus or the transmission means includes the data reception unit 115, the identification unit 116, the controller 117 and the data transmission unit 118.

As the setting process is finished, an operation is started. When the operation is started, the flow-rate acquisition unit 111, the flow-rate aggregation unit 110 and the flow-rate-policy control unit 107 begin to work.

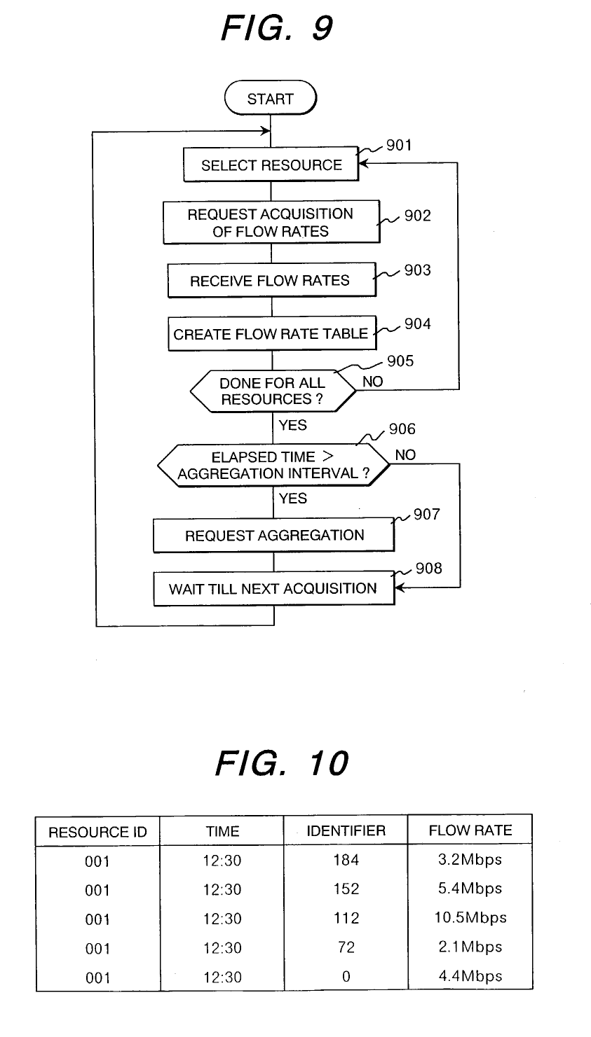

FIG. 9 shows a flowchart representing a procedure of a process carried out by the flow-rate acquisition unit 111. The flow-rate acquisition unit 111 acquires a flow rate information from a meter 10 periodically. The intervals at which a flow rate is acquired are determined at the initialization time. A flow rate is acquired from a meter 104 only for data subjected to traffic management for each resource.

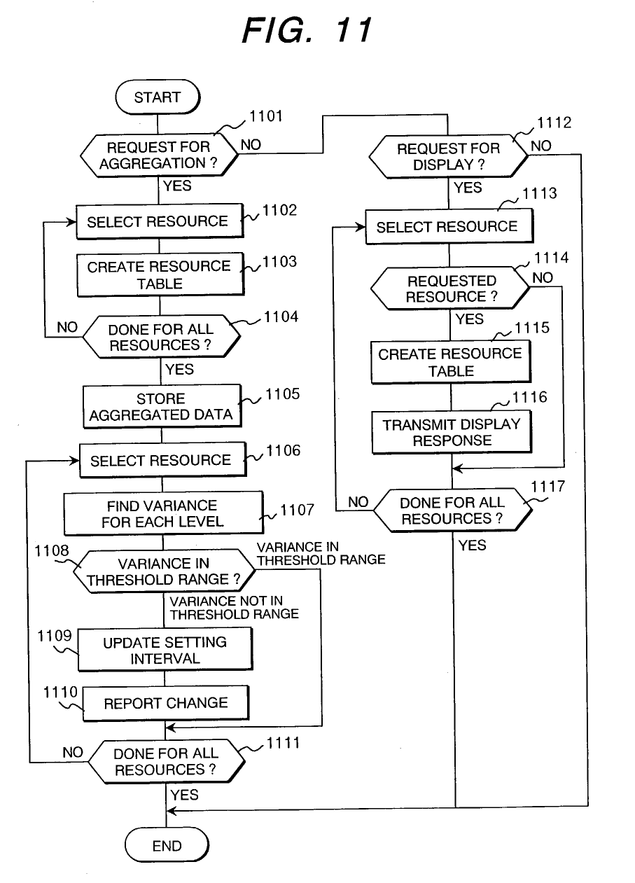

The flowchart begins with a step 901 at which, by referring to the resource information 201, a resource for which a flow rate is acquired is selected. Then, at the next step 902, a request for acquisition of a flow rate for a resource is transmitted to a meter 104 for measuring the flow rate. The meter 104, to which the request is transmitted, is specified by using an IP address. A service level is expressed by an identifier associated with the service level. According to the service-level definition shown in FIG. 4, flow rates of data with ToS values (identifiers) of 184, 152, 112, 72 and 0 are acquired. Subsequently, at the next step 903, the flow rates are received from the meter 104. Then, at the next step 904, the flow-rate acquisition unit 111 creates a table like one shown in FIG. 10. Flow rates shown in the table of FIG. 10 are send-out rates sampled at particular times shown in the table.

The table shown in FIG. 10 shows, for each resource ID, a time at which a flow rate has been measured, a condition (or an identifier) of the flow rate and the flow rate itself.

When the operation to acquire the flow rate is completed, the flow of the processing goes on to a step 905 to form a judgment as to whether or not it is necessary to acquire flow rates for a next resource. If the operation to acquire flow rates for all resources has not been completed, the flow of the processing goes back to the step 901 to acquire flow rates for the next resource. If the operation to acquire flow rates for all resources has been completed, on the other hand, the flow of the processing goes on to a step 906 to compare a time elapsing since the immediately preceding aggregation of flow rates with an aggregation interval set at the initialization time. If the time elapsing since the immediately preceding aggregation of flow rates has exceeded the aggregation interval, the flow of the processing goes on to a step 907 at which a request for an aggregation of flow rates is issued to the flow-rate aggregation unit 110. Then, the flow of the processing goes on to a step 908 to enter a state of waiting for an acquisition time set at the initialization time to lapse before going back to the step 901 to again acquire flow rates for the first resource.

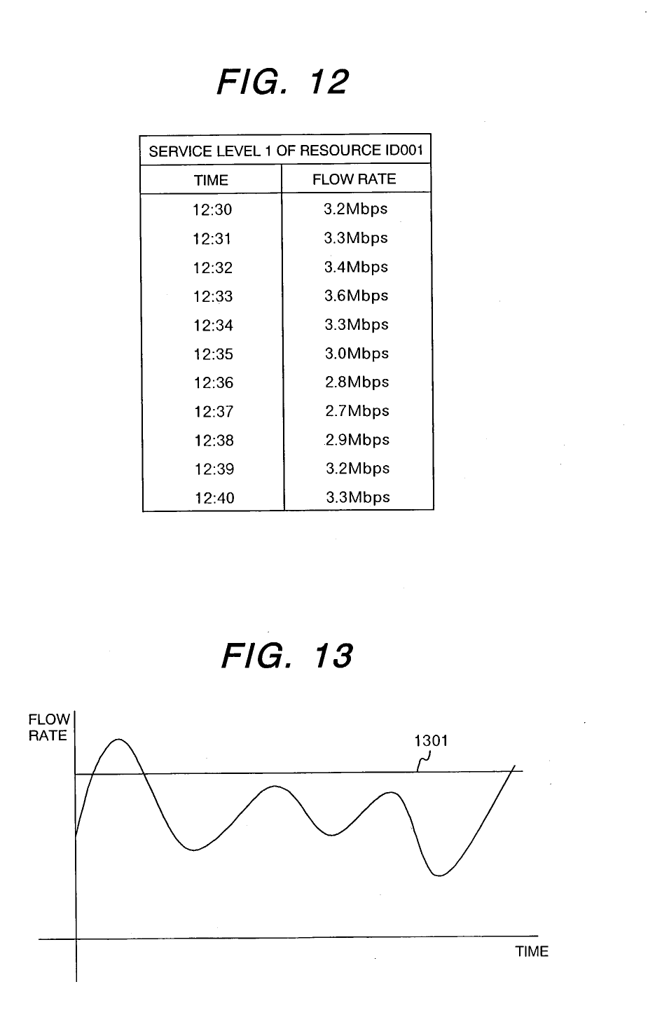

FIG. 11 shows a flowchart representing a procedure of a process carried out by the flow-rate aggregation unit 110. The flowchart begins with a step 1101 at which the flow-rate aggregation unit 110 forms a judgment as to whether or not a received request is a request for aggregation of flow rates that has been received from the flow-rate acquisition unit 111. If the received request is not a request for aggregation of flow rates that has been received from the flow-rate acquisition unit 111, the flow of the processing goes on to a step 1112 at which the flow-rate aggregation unit 110 forms a judgment as to whether or not the received request is a display request received from the flow-rate-data display unit 109. If the received request is a request for aggregation of flow rates that has been received from the flow-rate acquisition unit 111, on the other hand, the flow of the processing goes on to a step 1102 at which the flow-rate aggregation unit 110 receives a table like the one shown in FIG. 10, and selects a resource. Then, at the next step 1103, a table is created for the resource and for each service level in a format shown in FIG. 12. As shown in the figure, the table includes flow rates sampled at different times for a resource identified by a resource ID of 001 and for a service level of 1. Subsequently, at the next step 1104, the flow-rate aggregation unit 110 forms a judgment as to whether or not flow rates for different service levels have been aggregated for all resources. The operations of the steps 1102 to 1104 are carried out till flow rates for different service levels have been aggregated for all resources.

As flow rates for different service levels have been aggregated for all resources, the flow of the processing goes on to a step 1105 at which the aggregated data is stored in the acquired-flow-rate data 113 in the format shown in FIG. 12. Then, at the next step 1106, a resource associated with tables of aggregated data, which are each created for a service level, is again selected. Subsequently, at the next step 1107, in order to form a judgment as to whether or not an interval of setting a flow-rate policy is proper, a variance of aggregated flow rates is found for each service level by using the following equation:

$$S = \sqrt{\frac{\sum ( {v}_{t} - \overline{v} )}{T}} \qquad ( Equation 2 )$$

where symbol S denotes a computed value of the variance, ν t denotes a flow rate sampled at an acquisition time, over-lined symbol ν denotes the average value of flow rates sampled at different acquisition times and symbol T denotes the number of acquisitions.

Then, the flow of the processing goes on to a step 1108 at which the computed value S of the variance is examined to form a judgment as to whether or not the computed value S is within a predetermined threshold range used for changing the flow-rate policy. If the computed value S of the variance is outside the predetermined threshold range, the flow of the processing goes on to a step 1109 at which the flow-rate aggregation unit 110 changes the interval of setting the flow-rate policy. To be more specific, if the computed value S of the variance is greater than the upper limit of the predetermined threshold range, the flow-rate aggregation unit 110 reduces the interval of setting the flow-rate policy in order to set the flow-rate policy more frequently. If the computed value S of the variance is smaller than the lower limit of the predetermined threshold range, on the other hand, the flow-rate aggregation unit 110 increases the interval of setting the flow-rate policy in order to set the flow-rate policy less frequently. Then, at the next step 1110, the flow-rate aggregation unit 110 informs the flow-rate-policy control unit 107 of the new interval of setting the flow-rate policy. Subsequently, the flow of the processing goes on to a step 1111. If the judgment formed at the step 1108 indicates that the computed value S of the variance is within the predetermined threshold range, on the other hand, the flow of the processing goes on directly to the step 1111. At the step 1111, the flow-rate aggregation unit 110 forms a judgment as to whether or not the operations of the steps 1107 to 1110 have been carried out for all resources. The operations of the steps 1106 to 1111 are carried out till the operations of the steps 1107 to 1110 have been performed for all resources.

The flow-rate-data display unit 109 is a program for displaying measured flow rates as a graph. When the operator wants to verify-information on flow rates, the operator issues a display request to the flow-rate-data display unit 109. Receiving the display request, the flow-rate-data display unit 109 issues another request specifying a resource ID to the flow-rate aggregation unit 110. At a step 1112, the flow-rate aggregation unit 110 forms a judgment as to whether or not the other request is a display request. If the result of the judgment is Yes indicating that the other request is a display request, the flow of the processing goes on to a step 1113 at which a resource in the aggregated data is selected. Then, at the next step 1114, the flow-rate aggregation unit 110 forms a judgment as to whether or not the selected resource is the requested resource specified in the other request. If the selected resource is the requested resource, the flow of the processing goes on to a step 1115 at which a resource table is created. Then, at the next step 1116, the resource table is transferred to the flow-rate-data display unit 109 in response to the other request. Subsequently, at the next step 1117, the flow-rate aggregation unit 110 forms a judgment as to whether or not the operations of the steps 1114 to 1116 have been carried out for all resources. If the operations of the steps 1114 to 1116 have not been carried out for all resources, the flow of the processing goes on to a step 1113 to repeat the operations of the steps 1113 to 1117 till the operations of the steps 1114 to 1116 are carried out for all resources. Receiving the responses from the flow-rate aggregation unit 110, the flow-rate-data display unit 109 displays a graph based on the table shown in FIG. 12 on the display unit like one shown in FIG. 13. FIG. 13 is a diagram showing a graph representing changes in flow rate with the lapse of time for a specific resource and for a particular service level. A straight line 1301 shown in FIG. 13 represents a send-out rate set at an acquisition time. The operator is capable of issuing a request for a change in flow-rate policy to the flow-rate-policy-setting unit 108 by moving the straight line 1301 in the upward or downward direction through an operation carried out on the display screen.

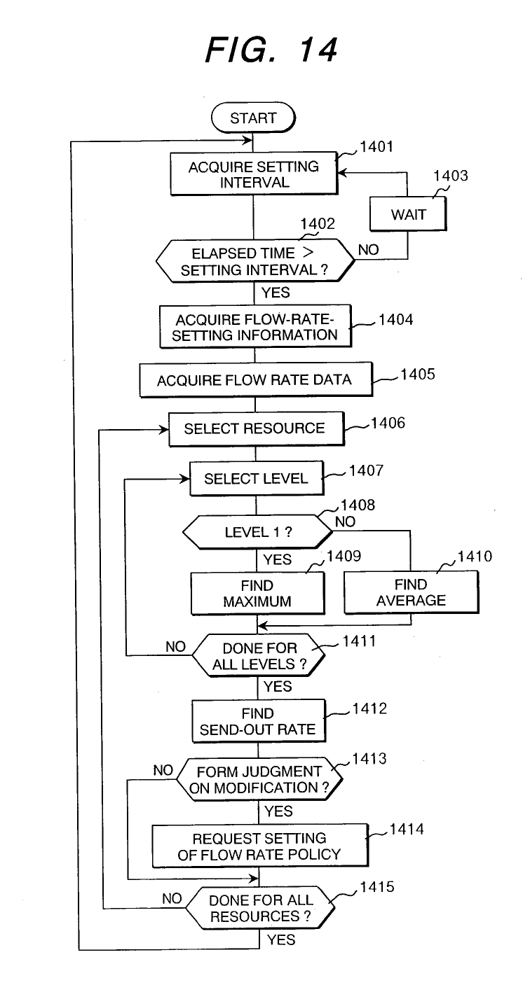

FIG. 14 shows a flowchart representing a procedure of a process carried out by the flow-rate-policy control unit 107. The flow-rate-policy control unit 107 sets a flow-rate policy periodically at intervals computed by the flow-rate aggregation unit 110 or intervals set by the operator. The flowchart shown in FIG. 14 begins with a step 1401 at which the flow-rate-policy control unit 107 acquires an interval of setting a flow-rate policy from the initialization data 112. Then, at the next step 1402, the flow-rate-policy control unit 107 compares a time elapsing since a last operation to set a flow-rate policy with the acquired interval in order to form a judgment as to whether or not the elapsed time is greater than the setting interval. If the elapsed time is not greater than the setting interval, the flow of the processing goes on to a step 1403 to enter a wait state for one second. Then, after the wait state has elapsed for one second, the flow of the processing goes back to the step 1401 at which the flow-rate-policy control unit 107 again acquires an interval of setting a flow-rate policy from the initialization data 112. If the elapsed time is greater than the setting interval, on the other hand, the flow of the processing goes on to a step 1404 at which the flow-rate-policy control unit 107 acquires current information on a flow-rate policy from the all-flow-rate-policy data 114. Then, at the next step 1405, the flow-rate-policy control unit 107 acquires flow-rate information from the acquired-flow-rate data 113.

Subsequently, at the next step 1406, a resource is selected. Then, at the next step 1407, a service level is selected. Subsequently, the flow of the processing goes on to a step 1408 to form a judgment as to whether or not the selected service level is the service level of 1. If the result of the judgment formed at the step 1408 is Yes, indicating that the selected service level is the service level of 1, the flow of the processing goes on to a step 1409 at which a maximum value of the flow rates is extracted since the service level is a level whose data is to be treated absolutely with the highest priority level. If the result of the judgment formed at the step 1408 is No, indicating that the selected service level is not the service level of 1, on the other hand, the flow of the processing goes on to a step 1410 at which a traffic average value of the flow rates is found for the service level. Then, the flow of the processing goes on from either the step 1409 or 1410 to a step 1411 to form a judgment as to whether or not the operations of the steps 1408 and 1409 or 1410 have been carried out for all service levels. If the results of the judgment formed at the step 1411 is Yes, indicating that the operations of the steps 1408 and 1409 or 1410 have been carried out for all service levels, the flow of the processing goes on to a step 1412 at which a send-out rate is computed for each service level.

A send-out rate for the service level of 1 is computed in accordance with the following equation:

r₁ₜ=(ν₁ₘₐₓνVr₁₍ₜ₋₁₎ (Equation 3)

where symbol Ξ1max denotes the maximum value of the flow rates for the service level of 1, symbol r1t denotes a send-out rate set at the present time for the service level of 1 and symbol r1(t−1) denotes a send-out rate set at the immediately preceding time for the service level of 1. That is to say, since data with the service level of 1 takes precedence of any other data, the maximum value of the traffic is used as a send-out rate as it is. If the maximum value of the traffic is smaller than the send-out rate used so far, however, the send-out rate is not changed.

On the other hand, a send-out rate for a service level other than the service level of 1 is computed in accordance with the following equation:

$${r}_{n t} = \frac{( V - {r}_{1 t} ) {γ}_{n} {\overline{v}}_{n}}{\sum {γ}_{k} {\overline{v}}_{k}} \qquad ( Equation 4 )$$

where over-lined symbol νn denotes the average flow rate for a service level of n other than the service level of 1 and symbol rnt denotes a send-out rate set this time for a service level of n other than the service level of 1. Thus, Eq. (4) indicates that a send-out rate for a specific service level other than the service level of 1 is the specific service level's average flow rate weighted by a quantity according to the specific service level.

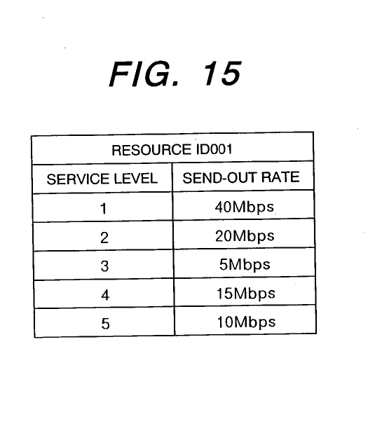

Then, at the next step 1413, the computed send-out rate is compared with the present send-out rate to form a judgment as to whether or not the flow-rate policy needs to be changed. If a difference between the computed send-out rate and the present send-out rate is greater than a predetermined threshold value, the flow of the processing goes on to a step 1414 at which a table shown in FIG. 15 is created to include computed send-out rates for all service levels, and a request for setting of a flow-rate policy is submitted to the flow-rate-policy-setting unit 108. Subsequently, the flow of the processing goes on to a step 1415 at which the flow-rate-policy control unit 107 forms a judgment as to whether or not the operations of the steps 1407 to 1414 have been carried out for all service levels. If the operations of the steps 1407 to 1414 have not been carried out for all service levels, the flow of the processing goes back to the step 1406 to repeat the operations of the steps 1406 to 1415. The operations of the steps 1406 to 1415 are carried out repeatedly till the operations of the steps 1407 to 1414 are performed for all service levels. Receiving the request for setting of a flow-rate policy, the flow-rate-policy-setting unit 108 sets a flow-rate policy in an interface of a router 102 subjected to traffic management on the basis of the table shown in FIG. 15.

By carrying out the series of operations described above, the send-out rate of each router in the network subjected to traffic management is constantly updated in accordance with the traffic of the network.

In accordance with the present invention, flow rates in the network can be controlled dynamically in dependence on the traffic in the network.

What is claimed is:

1. A traffic flow-rate control method for controlling a traffic flow rate of a communication line in a network comprising a plurality of routing controllers and said communication line connecting said routing controllers to each other, said traffic flow-rate control method comprising the steps of:
sampling traffic flow rates for each transmission direction of said communication line and for each identifier included in transmitted data;
aggregating said sampled traffic flow rates to find an average value of said sampled traffic flow rates;
finding a send-out rate by multiplying said average value by a weight according to said identifier to be used as a flow-rate policy; and
transmitting said send-out rate to one of said routing controllers to set said send-out rate as said flow-rate policy.

2. A traffic flow-rate control method according to claim 1 wherein, a variance of said sampled traffic flow rates is found and, if said variance is outside a predetermined range of threshold values, an interval of setting said flow-rate policy is changed in accordance with the magnitude of said variance.

3. A traffic flow-rate control method adopted by a system, which has a management means for managing traffic flow rates in a network, for the purpose of controlling a traffic flow rate of transmitted data flowing through a communication line in said network comprising a plurality of transmission means, said communication line connecting said transmission means to each other and a measurement means for measuring said traffic flow rate, said traffic flow-rate control method comprising the steps of:
driving said measurement means to measure a traffic flow rate of data transmitted through said communication line for each transmission direction of said communication line and for each identifier included in said transmitted data and transmit said measured traffic flow rate to said management means in accordance with a request received from said management means; and
driving each of said transmission means to receive a send-out rate as a flow-rate policy set for each transmission direction of said communication line and for each identifier included in said transmitted data from said management means and control said flow rate of said transmitted data for each identifier included in said transmitted data in accordance with said send-out rate received from said management means.

4. A program to be executed by a computer for the purpose of controlling a traffic flow rate of a communication line in a network comprising a plurality of routing controllers and said communication line connecting said routing controllers to each other, said program comprising functions of:
sampling traffic flow rates for each transmission direction of said communication line and for each identifier included in transmitted data;
aggregating said sampled traffic flow rates to find an average value of said sampled traffic flow rates;
finding a send-out rate by multiplying said average value by a weight according to said identifier to be used as a flow-rate policy; and
transmitting said send-out rate to one of said routing controllers to set said send-out rate as said flow-rate policy.

5. A program according to claim 4, said program providing said computer with a further function of finding a variance of said sampled traffic flow rates and changing an interval of setting said flow-rate policy in accordance with the magnitude of said variance for a value of said variance outside a predetermined range of threshold values.

6. A traffic flow-rate control apparatus for controlling a traffic flow rate of a communication line in a network comprising a plurality of routing controllers and said communication line connecting said routing controllers to each other, said traffic flow-rate control apparatus comprising:
a sampling means for sampling traffic flow rates for each transmission direction of said communication line and for each identifier included in transmitted data;
an aggregation means for aggregating said sampled traffic flow rates to find an average value of said sampled traffic flow rates;
a computation means for finding a send-out rate by multiplying said average value by a weight, according to said identifier to be used as a flow-rate policy; and
a transmission means for transmitting said send-out rate to one of said routing controllers to set said send-out rate as said flow-rate policy.

7. A traffic flow-rate control apparatus according to claim 6, further comprising:
a variance computation means for finding a variance of said sampled traffic flow rates; and
an interval-changing means for changing an interval of setting said flow-rate policy in accordance with the magnitude of said variance for a value of said variance outside a predetermined range of threshold values.
